(19) United States
(12) Patent Application Publication
(10) Pub. No.: US 2025/0065787 A1
(43) Pub. Date: Feb. 27, 2025

(54) SEAT ACTUATOR CONTROL FOR LUMBAR SUPPORT

(71) Applicant: Toyota Motor Engineering & Manufacturing North America, Inc., Plano, TX (US)

(72) Inventors: Michael Paul Rowe, Pinckney, MI (US); Brian J. Pinkelman, Ann Arbor, MI (US); Yufei Zhu, Ypsilanti, MI (US); Xintong Deng, Belleville, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/452,734

(22) Filed: Aug. 21, 2023

(51) Int. Cl. B60N 2/66; B60N 2/02; B60N 2/90

(52) U.S. Cl. CPC B60N 2/667; B60N 2/0244; B60N 2/976; B60N 2/0268

(57) ABSTRACT

One or more actuators can be used to provide a substantially continuous level of lumbar support to a seat occupant. An actuator can be operatively positioned relative to a lumbar region of a seat. The actuator can be caused to morph into an activated configuration to support a lumbar region of a seat occupant. The activated configuration of the actuator can be maintained to provide a substantially continuous level of lumbar support.

### FIELD

The subject matter described herein relates in general to seats and, more particularly, to seats that provide a haptic effect.

### BACKGROUND

A vehicle typically includes a plurality of seats. There are numerous vehicle seat designs. Vehicles seats can be contoured and/or can include features to provide support and comfort to a vehicle occupant. Some vehicle seats can include various ergonomic features to enhance user comfort. Some vehicle seats can provide a haptic effect to a user. Further, lumbar support pillows can be used to facilitate comfortable and ergonomic seating.

### SUMMARY

In one respect, the present disclosure is directed to a system for seat actuation. The system can include a seat and an actuator operatively positioned relative to a lumbar region of the seat. The system can include one or more processors operatively connected to the actuator. The one or more processors can be configured to cause the plurality of actuators to morph into an activated configuration to support a lumbar region of a seat occupant. The one or more processors can be configured to maintain the activated configuration of the actuator. Thus, a substantially continuous level of lumbar support is provided to the seat occupant.

In another respect, the present disclosure is directed to a seat actuation method for lumbar support. An actuator can be operatively positioned relative to a lumbar region of a seat. One or more processors can be operatively connected to the actuator. The method can include causing the actuator to morph into an activated configuration to support a lumbar region of a seat occupant. The method can include maintaining the activated configuration of the actuator. Thus, a substantially continuous level of lumbar support is provided to the seat occupant.

### BRIEF DESCRIPTION OF THE DRAWINGS

FIG. 1 is an example of a seat.

FIG. 2 is an example of a system for actuation of a seat.

FIG. 3 is an example of a method of seat actuation.

FIG. 4 is an example of a user interface for an actuator.

FIG. 5A-5C is a first example of an actuator.

FIGS. 6A-6B is a second example of an actuator.

FIGS. 7A-7B is a third example of an actuator.

FIG. 8 is a fourth example of an actuator.

### DETAILED DESCRIPTION

While lumbar support pillows can provide some level of support to a user, they cannot adjust for changes in position of a seat occupant and/or in the seat itself. According to arrangements described herein, actuators can be used to provide a substantially continuous level of lumbar support to a seat occupant. One or more n actuators can be operatively positioned relative to a lumbar region of a seat. The one or more actuators can be caused to morph into an activated configuration to support a lumbar region of a seat occupant. The activated configuration of the actuators can be maintained to provide a substantially continuous level of lumbar support. In some arrangements, there can also be one or more actuators operatively positioned relative to a non-lumbar region of the seat. In some arrangements, such actuator(s) can provide a different sensation to the seat occupant than the actuator(s) operatively positioned relative to the lumbar region.

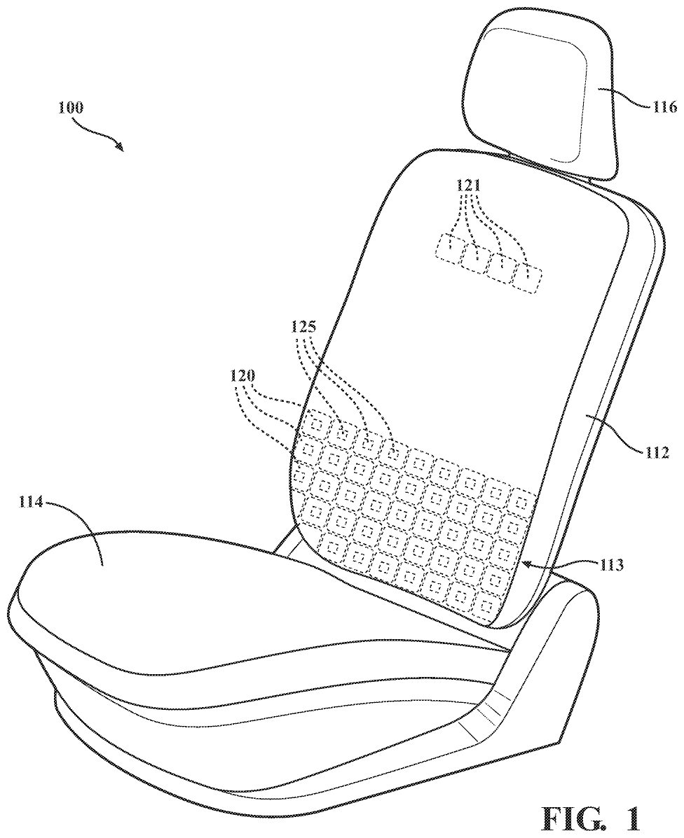

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of a seat 100 is shown. In one or more arrangements, the seat 100 can be a vehicle seat. The seat 100 can be any type of vehicle seat, now known or later developed. The seat 100 can be for any vehicle occupants, such for a driver and/or for a passenger. The seat will be described herein with respect to a vehicle seat, but it will be appreciated that arrangements are not limited to vehicle seats. Indeed, the seat 100 can be an office chair, a chair, a massage chair, a gaming chair, a recliner, or any other seat structure, now known or later developed.

The seat 100 can have any suitable configuration. For instance, the seat 100 can include a back portion 112 and a seat portion 114. The back portion 112 and/or the seat portion 114 can include bolsters. In some arrangements, the seat 100 can include a headrest 116 and/or arm rests.

The seat 100 can include one or more actuators. The one or more actuators can be operatively positioned relative to one or more surfaces or portions of the seat 100. The one or more surfaces can be a surface of the back portion 112, the seat portion 114, a bolster of the back portion 112, a bolster of the seat portion 114, headrest 116, an arm rest, or any combination or subset thereof.

In some arrangements, there can be a single actuator associated with the seat. In other arrangements, there can be a plurality of actuators associated with the seat 100. When actuated, the one or more actuators can cause the surface(s) or portion(s) of the seat 100 to morph into a different configuration and/or the one or more actuators can provide a physical sensation to a portion of a seat occupant's body that is in operative contact with the seat 100. “Operative contact” includes direct contact as well as indirect contact, such as through the seat 100 (e.g., upholstery, padding, cushioning, etc.) or the clothing of a seat occupant.

The actuator(s) can be operatively positioned relative to the seat 100. “Operatively positioned relative to” means that the actuators are positioned in a location that, when activated, provides a physical sensation to a person sitting in the seat 100. In one or more arrangements, the actuator(s) 120 can be located within a portion of the seat 100. For instance, the actuator(s) 120 can be located within the back portion 112, the seat portion 114, the bolster of the back portion 112, the bolster of the seat portion 114, the headrest 116, one or more arm rests, or any combination or subset thereof.

In one or more arrangements, there can be one or more actuators 120 can be located in a lumbar region 113 of the back portion 112. In this context, “lumbar region” means a portion of the seat that would correspond to at least a portion of the lumbar region of a seat occupant's back. The actuator(s) 120 may be interchangeably referred to herein as first actuator(s) 120.

In arrangements in which there is a plurality of actuators 120, the plurality of actuators 120 can be substantially identical to each other. Alternatively, one or more of the actuators 120 can be different from the other actuators 120 in one or more respects, such as size, shape, configuration, actuation effect, etc. The plurality of actuators 120 can be distributed in any suitable manner with respect to the lumbar region 113 of the seat 100. In some instances, the plurality of actuators 120 can be arranged in rows and columns. In such instances, the actuators 120 in a row or in a column can be adjacent to each other. Alternatively, there can be a spacing between at least some of the actuators 120 in the row or column. In some instances, the plurality of actuators 120 can be arranged in a plurality of discrete areas, which may or may not be spaced apart.

When there is a plurality of rows of the actuators 120, the rows can, in some arrangements, have the same quantity of actuators, types of actuators, distribution of actuations, arrangement of actuators, or other aspect. However, in other arrangements, when there is a plurality of rows of actuators 120, the rows can be different from each other in one or more respects, including any of those noted herein. The plurality of rows of the actuators 120 can be adjacent to each other. Alternatively, the rows of the actuators 120 can be spaced apart.

When there is a plurality of columns of the actuators 120, the columns can, in some arrangements, have the same quantity of actuators, types of actuators, distribution of actuations, arrangement of actuators, or other aspect. However, in other arrangements, when there is a plurality of columns of actuators 120, the columns can be different from each other in one or more respects, including any of those noted herein. The columns of rows of the actuators 120 can be adjacent to each other. Alternatively, the columns of the actuators 120 can be spaced apart.

In some arrangements, there can be a single actuator 120 operatively positioned relative to the lumbar region 113. The single actuator 120 can be provided in any suitable location. In some instances, the single actuator 120 can span a portion of the width of the lumbar region 113. In some instances, the single actuator 120 can span at least a majority of the width of the lumbar region 113. In some instances, the single actuator 120 can span the entire width of the lumbar region 113. In some instances, the single actuator 120 can span a portion of the height of the lumbar region 113. In some instances, the single actuator 120 can span a majority of the height of the lumbar region 113. In some instances, the single actuator 120 can space the entire height of the lumbar region 113. In some arrangements, the single actuator 120 operatively positioned relative to the lumbar region 113 can be the only actuator associated with the seat 100.

In some arrangements, a plurality of actuators 120 can be operatively positioned relative to the lumbar region 113. The plurality of actuators 120 can be provided in any suitable location. In some instances, the plurality of actuators 120 can span a portion of the width of the lumbar region 113. In some instances, the plurality of actuators 120 can span a majority of the width of the lumbar region 113. In some instances, the plurality of actuators 120 can span the entire width of the lumbar region 113. In some instances, the plurality of actuators 120 can span a portion of the height of the lumbar region 113. In some instances, the plurality of actuators 120 can span a majority of the height of the lumbar region 113. In some instances, the plurality of actuators 120 can space the entire height of the lumbar region 113. In some arrangements, the plurality of actuators 120 operatively positioned relative to the lumbar region 113 can be the only actuators associated with the seat 100.

In some arrangements, there can be one or more actuators 121 located in one or more non-lumbar regions of the seat 100. The actuator(s) 121 may be referred to interchangeably herein as the second actuator(s) 121. “Non-lumbar regions” can include the seat portion 114, the bolster of the back portion 112, the bolster of the seat portion 114, the headrest 116, one or more arm rests, and/or any portion of the back portion 112 outside of the lumbar region 113. While a plurality of the second actuator 121 are shown in FIG. 1, it will be understand that there can be a single second actuator 121 located in non-lumbar regions of the seat 100, or there can be additional second actuators 121. The second actuator(s) 121 are not limited to the location or quantity shown in FIG. 1. The above discussion of the first actuator(s) 120 generally applies to the second actuator(s) 121; however, the second actuator(s) 121 are not operatively positioned with respect to the lumbar region 113 of the seat 100.

As will be described in more detail, one or more of the actuator(s) 120 in the lumbar region 113 can be activated. The activated actuator(s) 120 can remain in an activated condition to provide lumbar support to a seat occupant.

The actuator(s) 120 and the actuator(s) 121 can be any element or combination of elements operable to modify, adjust and/or alter one or more surfaces or portions of the seat 100. In FIG. 1, the actuator(s) 120 and the actuator(s) 121 are generally represented by a rectangular feature. It will be understood that the-actuator(s) 120 can be any suitable type of actuator, now known or later developed.

In some arrangements, the actuator(s) 120 and the actuator(s) 121 can be substantially identical to each other. In other arrangements, the actuator(s) 120 and the actuator(s) 121 can be different from each other in one or more respects, including in any respect described herein.

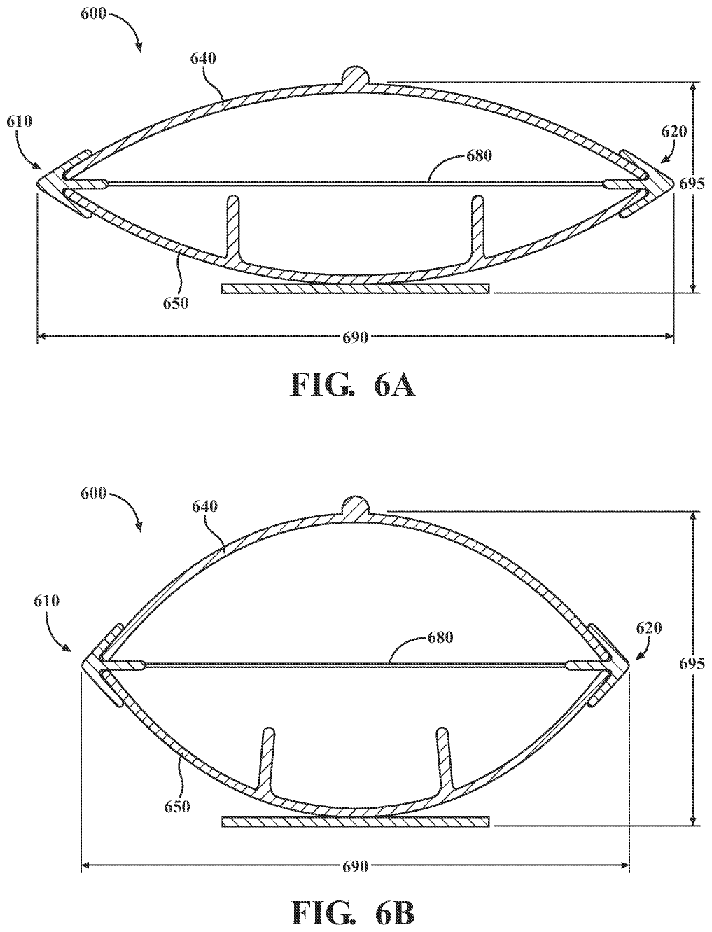

In some arrangements, the actuator(s) 120 can include a contracting member. When an activation input is provided to the contracting member, the contracting member can contract, thereby causing the actuator 120 to morph into an activated configuration in which a dimension (e.g., the height) of the actuator increases. In some arrangements, the contracting member can be a shape memory material member, which can include shape memory alloys and shape memory polymers. As an example, the contracting member can be a shape memory alloy wire. Various non-limiting examples of suitable actuators are shown in FIGS. 6-9, and they will be described in greater detail herein. In some instances, the actuator(s) 121 can include a contracting member.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members can be shape memory material wires. As an example, the shape memory material members can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material members are described, in some implementations, as being wires, it will be understood that the shape memory material members are not limited to being wires. Indeed, it is envisioned that suitable shape memory materials may be employed in a variety of other forms, such as sheets, plates, panels, strips, cables, tubes, or combinations thereof. In some arrangements, the shape memory material members may include an insulating coating.

In some arrangements, the actuator(s) 120 and the second actuator(s) 121 can be substantially the same actuators. However, in other arrangements, the actuator(s) 120 and the second actuator(s) 121 can be different from each other in one or more respects.

In one or more arrangements, the seat 100 can include a one or more sensors 125. In some arrangements, the sensor(s) 125 can be operatively positioned with a respect to a respective one of the actuator(s) 120. The sensor(s) 125 can be part of a feedback control loop for the actuator(s) 120. For instance, the sensor(s) 125 can be used to help to maintain the actuator(s) 120 in a particular condition, state, or configuration. In some arrangements, the sensor(s) 125 can be configured to detect, directly or indirectly, changes in the force applied to the lumbar region of seat occupant.

In one or more arrangements, the sensor(s) 125 can be flex sensors. The flex sensors can be any suitable type of flex sensor, now known or later developed. The flex sensors can be configured to change resistance when flexed. The flex sensors can be operatively positioned with respect to the actuator(s) 120. In some instances, the flex sensors can be operatively positioned on or within the actuator(s) 120. Thus, when an actuator 120 is activated or deactivated such that it morphs, the morphing of the actuator 120 can act upon the flex sensor so as to change resistance, which can be used to determine changes in a level of lumbar support provided to a seat occupant.

In one or more arrangements, the sensor(s) 125 can be rotational position sensors. The rotational position sensors can be configured to transform mechanical rotary movements and measurements into electrical signals. The rotational position sensors can be any suitable type of rotational position sensors, now known or later developed. In some instances, the rotational position sensors can be operatively positioned on or within the actuator(s) 120. Thus, when an actuator 120 is activated or deactivated such that it morphs, the morphing of the actuator 120 can act upon the rotational position sensors so as to change their output electrical signals, which can be used to determine changes in a level of lumbar support provided to a seat occupant.

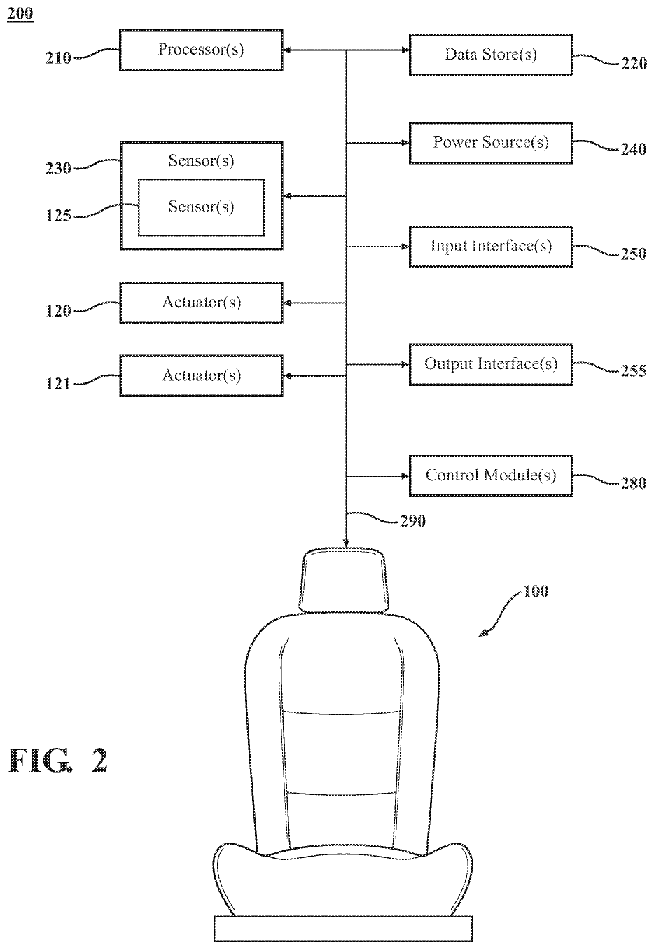

Referring to FIG. 2, an example of a system 200 for actuation of the seat 100 is shown. In some arrangements, the system 200 can be used in connection with a vehicle. As used herein, “vehicle” means any form of transport, including motorized or powered transport. In one or more implementations, the vehicle can be an automobile. While arrangements will be described herein with respect to automobiles, it will be understood that embodiments are not limited to automobiles. In some implementations, the vehicle may be a watercraft, an aircraft, spacecraft, or any other form of transport. Moreover, arrangements described herein are not limited to vehicles.

The system 200 can include various elements. Some of the possible elements of the system 200 are shown in FIG. 2 and will now be described. It will be understood that it is not necessary for the system 200 to have all of the elements shown in FIG. 2 or described herein. The system 200 can have any combination of the various elements shown in FIG. 2. Further, the system 200 can have additional elements to those shown in FIG. 2. In some arrangements, the system 200 may not include one or more of the elements shown in FIG. 2. Further, while the various elements may be located on or within a vehicle, it will be understood that one or more of these elements can be located external to the vehicle. Thus, such elements are not located on, within, or otherwise carried by the vehicle. Further, the elements shown may be physically separated by large distances. Indeed, one or more of the elements can be located remote from the vehicle, such an on a remote server or cloud-based server.

In addition to one or more seats 100 and one or more of the actuators 120, the system 200 can include one or more processors 210, one or more data stores 220, one or more sensors 230, one or more power sources 240, one or more input interfaces 250, one or more output interfaces 255, one or more transceivers 260, one or more personal device(s) 270, and/or one or more control modules 280. In some arrangements, the system 200 can also include one or more of the actuators 121. Each of these elements will be described in turn below.

As noted above, the system 200 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other.

The system 200 can include one or more data stores 220 for storing one or more types of data. The data store(s) 220 can include volatile and/or non-volatile memory. Examples of suitable data stores 220 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 220 can be a component of the processor(s) 210, or the data store(s) 220 can be operatively connected to the processor(s) 210 for use thereby. The term “operatively connected,” as used throughout this description, can include direct or indirect connections, including connections without direct physical contact.

In some arrangements, the data store(s) 220 can store one or more actuation profiles. The actuation profiles can include instructions for activating one or more of the actuator(s) 120, one or more of the actuator(s) 121, and/or other actuators in a specified manner. The actuation profiles can include activation patterns, activation sequences, activation zones, activation regions, activation times, activation of individual actuators or groups of actuators, etc. The actuation profiles can be created by an end user, a seat manufacturer, a vehicle manufacturer, or some other entity. In some instances, one or more actuation profiles can be received from a remote source. In some arrangements, one or more actuation profiles can be directed to providing lumbar support to a seat occupant.

The system 200 can include one or more sensors 230. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 200 includes a plurality of sensors 230, the sensors can work independently from each other. Alternatively, two or more of the sensors can work in combination with each other. In such case, the two or more sensors can form a sensor network. The sensor(s) 230 can be operatively connected to the processor(s) 210, the data store(s) 220, and/or other elements of the system 200 (including any of the elements shown in FIG. 1).

The sensor(s) 230 can include the sensor(s) 125 described above. In addition, the sensor(s) 230 can include any suitable type of sensor, now known or later developed, that can acquire information or data about the seat 100 or a seat occupant. For instance, the sensor(s) 230 can include weight sensors, seat position sensors, seat angle sensors, occupant position sensors, occupant presence sensors, etc. In one or more arrangements, the sensor(s) 230 can be used to detect the presence of an occupant in the seat 100.

As noted above, the system 200 can include one or more power sources 240. The power source(s) 240 can be any power source capable of and/or configured to energize the actuator(s) 120, as will be described later. For example, the power source(s) 240 can include one or more batteries, one or more fuel cells, one or more generators, one or more alternators, one or more solar cells, and combinations thereof. The power source(s) 240 can be any suitable source of electrical energy.

The system 200 can include one or more input interfaces 250. An “input interface” includes any device, component, system, element or arrangement or groups thereof that enable information/data to be entered into a machine. The input interface(s) 250 can receive an input from a vehicle occupant (e.g. a driver or a passenger). Any suitable input interface 250 can be used, including, for example, a keypad, gesture recognition interface, voice recognition interface, display, touch screen, multi-touch screen, button, joystick, mouse, trackball, microphone and/or combinations thereof.

The system 200 can include one or more output interfaces 255. An “output interface” includes any device, component, system, element or arrangement or groups thereof that enable information/data to be presented to a vehicle occupant (e.g. a person, a vehicle occupant, etc.). The output interface(s) 255 can present information/data to a vehicle occupant. The output interface(s) 255 can include a display. Alternatively or in addition, the output interface(s) 255 may include an earphone and/or speaker. Some components of the system 200 may serve as both a component of the input interface(s) 250 and a component of the output interface(s) 255.

The system 200 can include one or more modules, at least some of which will be described herein. The modules can be implemented as computer readable program code that, when executed by a processor, implements one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data stores 220 may contain such instructions. In some arrangements, the module(s) can be located remote from the other elements of the system 200.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 200 can include one or more control modules 280. The control module(s) 280 can include profiles and logic for controlling the actuators 120. The control module(s) 280 can use profiles, parameters, or settings loaded into the control module(s) 280 and/or stored in the data store(s) 220, such as the actuation profiles. In some arrangements, the control module(s) 280 can be located remotely from the other elements of the system 200, such as on a remote server, a cloud-based server, or an edge server.

The control module(s) 280 can be configured to cause one or more of the actuator(s) 120 and/or the actuator(s) 121 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 280 can cause the actuator(s) 120 to be selectively activated or deactivated in any suitable manner. For instance, when the actuator(s) 120 include a shape memory material member or other contracting member, the shape memory material member can be heated by the Joule effect by passing electrical current through the shape memory material member. To that end, the control module(s) 280 can be configured to selectively permit, restrict, adjust, alter, and/or prevent the flow of electrical energy from the power source(s) 240 to the one or more shape memory material members of the actuator(s) 120. The control module(s) 280 can be configured to send control signals or commands over a communication network 290 to the shape memory material members or to other elements of the system 200.

The control module(s) 280 can be configured to cause the actuator(s) 120 to be activated or deactivated individually, in one or more groups, or in one or more regions of the seat 100. The control module(s) 280 can be configured to cause the actuator(s) 120 to be activated or deactivated based on various events, conditions, inputs, or other factors. For instance, the control module(s) 280 can be configured to cause the actuator(s) 120 to be activated or deactivated based on a user input. A user can provide an input on the input interface(s) 250. The input can be a command to implement one of the actuation profiles. The input can be a command to activate or deactivate the one or more of the actuators 120 based on the previously used actuation profile or a default actuation profile. In some instances, the input can be a newly defined actuation profile. The user can define parameters, profiles, and characteristics for individual actuators 121 or a plurality of actuators 121.

In some arrangements, the control module(s) 280 can be configured to cause the actuator(s) 120 to be activated or deactivated. In some instances, the control module(s) 280 can be configured to adjust the degree of activation of the actuator(s) 120. For instance, the control module(s) 280 can be configured to cause the actuator(s) 120 to be in an activated configuration that corresponds to its full activated position (e.g., extended to its maximum height). The control module(s) 280 can be configured to activate the actuator(s) 120 to one or more activated configurations between the non-activated configuration and the full activated configuration, such as an extended position but less than its maximum height.

In some arrangements, the control module(s) 280 can cause the actuator(s) 120 to be activated to provide a desired level of lumbar support to the seat occupant. Such causing can be performed based on a user input. The control module(s) 280 can be configured to cause the actuator(s) 120 to be morphed into an activated configuration that corresponds to the desired lumbar support.

The control module(s) 280 can be configured to maintain the activated configuration of the actuator(s) 120. Thus, a substantially continuous level of lumbar support can be provided to the seat occupant. The control module(s) 280 can do so in any suitable manner. For instance, the control module(s) 280 can receive sensor data (e.g., from the sensor(s) 125 and/or the sensor(s) 230) about the actuator(s) 120. The control module(s) 280 can be configured to adjust the activated configuration of the actuator(s) 120 based on the sensor data. Adjusting the activating configuration includes increasing or decreasing the level of activation of one or more of the actuator(s) 120 so that the desired level of lumbar support to the seat occupant is substantially maintained. The control module(s) 280 can be configured to analyze data or information acquired by the sensor(s) 230 (e.g., sensors 125 or other sensors) to select an activated configuration that may be suitable for the user. For instance, the control module(s) 280 can be configured to detect changes in resistance using sensor data from the flex sensors. When such changes are detected, the control module(s) 280 can be configured to adjust the activated configuration of the actuator(s) 120 as appropriate the desired level of lumbar support is substantially maintained. The control module(s) 280 can be configured to maintain the actuator(s) 120 in an activated configuration such that a force applied to the lumbar region of a seat occupant is maintained.

In some instances, the control module(s) 280 can be configured to selectively activate one or more of the actuator(s) 121 corresponding to non-lumbar regions of the seat 100. The actuator(s) 121 can provide a different sensation to the seat occupant than the actuator(s) 120. For instance, the different sensation can be a massaging effect. In some arrangements, the control module(s) 280 can be configured to simultaneously provide a massaging effect by the actuator(s) 121 and lumbar support by the actuator(s) 120.

The various elements of the system 200 can be communicatively linked to one another or one or more other elements through one or more communication networks 290. As used herein, the term “communicatively linked” can include direct or indirect connections through a communication channel, bus, pathway or another component or system. A “communication network” means one or more components designed to transmit and/or receive information from one source to another. The data store(s) 220 and/or one or more other elements of the system 200 can include and/or execute suitable communication software, which enables the various elements to communicate with each other through the communication network and perform the functions disclosed herein.

The one or more communication networks 290 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

Now that the various potential systems, devices, elements and/or components of the system 200 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

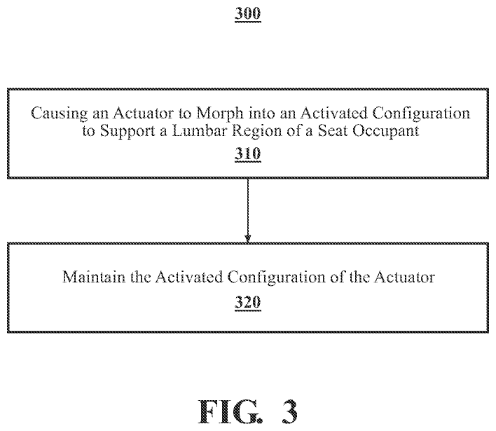

Turning to FIG. 3, an example of a method 300 of seat actuation is shown. As described above, an actuator 120 can be operatively positioned relative to a lumbar region of a seat 100. One or more processors 210 can be operatively connected to the actuator 120. While the method 300 will be described in connection with a single actuator 120, it will be appreciated that the method 300 applied to arrangements in which there are a plurality of actuators 120.

At block 310, the actuator 120 can be caused to morph into an activated configuration to support a lumbar region of a seat occupant. Such causing can be performed by the processor(s) 210 and/or the control module(s) 280. For instance, the processor(s) 210 and/or the control module(s) 280 can cause electrical energy from the power source(s) 240 (or energy from any other suitable source) to be supplied to the actuator 120. More particularly, the processor(s) 210 and/or the control module(s) 280 can cause electrical energy from the power source(s) 240 (or energy from any other suitable source) to be supplied to contracting member(s) s (e.g., shape memory material member(s), shape memory alloy wire(s), etc.) of the actuators 120. When the actuator 120 morphs into the activated configuration, a dimension (e.g., the height) of the actuator 120 can increase. The causing can be performed automatically, in response to a user input (e.g., provided on the input interface(s) 250), or in any other suitable way. The method 300 can continue to block 320.

At block 320, the activated configuration of the actuator 120 can be maintained. Thus, a substantially continuous level of lumbar support can be provided to the seat occupant. The maintaining of the activated configuration can be performed by the processor(s) 210 and/or the control module(s) 280. The maintaining can include adjusting the activated configuration of the actuator 120. Such adjusting can be performed in real-time based on data acquired by the sensor(s) 230 and/or the sensor(s) 125. The maintaining can include adjusting the activated configuration of the actuator 120 so that maintain the substantially continuous level of lumbar support. Adjusting the activated configuration can include increasing or decreasing the actuated position or force output of the actuator 120 (or one or more individual actuators 120 when there is a plurality of actuators 120). The increasing or decreasing the actuated position or force output can be performed by adjusting the supply of electrical energy from the power source(s) 240 (or energy from any other suitable source) to the actuator 120. In some arrangements, the activated configuration can be maintained by keeping the supply of electrical energy (or other form of energy) to the actuator 120 substantially constant.

The method 300 can end. Alternatively, the method 300 can return to block 310 or to some other block. The method 300 can be repeated at any suitable point, such as at a suitable time or upon the occurrence of any suitable event or condition.

Arrangements described herein can be customized by a user. Thus, a user can define a new actuation profile, or the user can modify an existing actuation profile. A user can adjust a currently implemented actuation profile in real-time. Arrangements described herein can enable a user to program individual actuators 120 and/or or a plurality of the actuators 120. Arrangements described herein can enable a user to program individual actuators 121 and/or or a plurality of the actuators 121. Such customization can be effectuated in various ways.

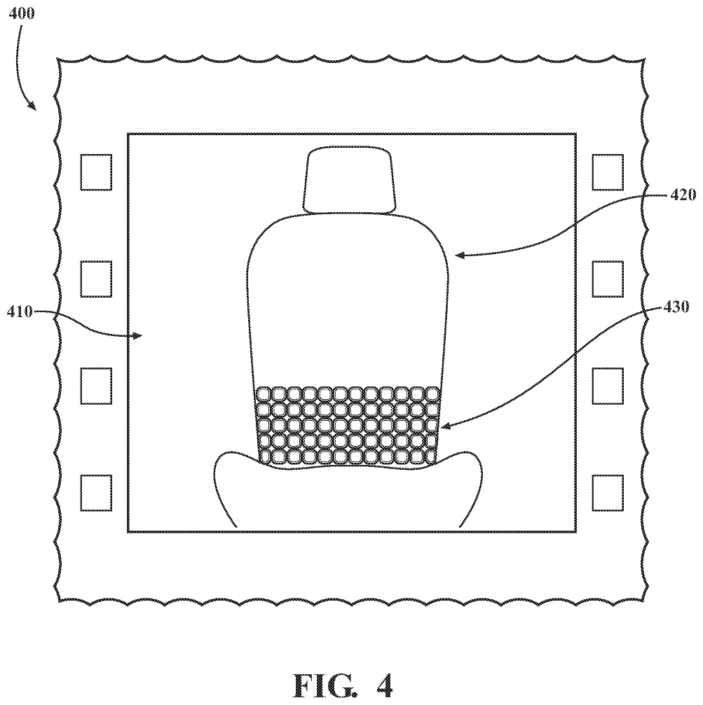

FIG. 4 shows one example in which a user interface is presented on a display 400. The display can be a part of the output interface(s) 255 and/or the input interface(s) 250 of the system 200. In one or more arrangements, the display 400 can be part of a vehicle infotainment system or head unit of a vehicle. In some arrangements, the display 400 can be a portion of another vehicle system, such as a navigation system, a vehicle radio or audio system, a backup camera display, and/or other vehicle monitor. In one or more arrangements, the display 400 can be located in a front interior portion of the vehicle. For instance, the display 400 can be included in a dashboard or instrument panel of the vehicle. Of course, it will be appreciated that arrangements described herein can be customized using other user interfaces, such as on a portable communication device (e.g., a cellular telephone, a smart phone, etc.), a voice interface, a gesture interface, a computer (e.g., a laptop, a tablet, a phablet, etc.), etc.

The display 400 can be any suitable type of display, now known or later developed. In one or more arrangements, the display 400 can be a touch screen display, which can allow a user to engage or interact with one or more displayed elements, such as a graphical user interface (GUI) 410, and/or other applications running on any vehicle system, including any of those described herein, through contact with the forward display. For example, a user may make selections and/or move a cursor by simply touching the display 400 via a finger or stylus.

In the example shown in FIG. 4, the GUI 410 can present a representation of at least a portion of the seat 420. A representation of one or more actuators 430 can be presented on the representation of the seat 420. The representation of the one or more actuators 430 can correspond to the location of the actuator(s) (e.g., actuator(s) 120) associated with the seat (e.g., seat 100) of the vehicle. The GUI 410 can be presented automatically whenever the actuators are in use, when requested by a user, or upon some other condition or event.

In some arrangements, the GUI 410 can be configured to present a currently in use activation profile. The GUI 410 can show which of the actuator(s) are activated, such as by highlighting them. The GUI 410 can be updated in real time to show changes in the actuator(s). Additional or alternative effects can be used to represent a status or condition of the actuator(s).

In some arrangements, the GUI 410 can allow a user to define a new activation profile and/or modify an existing activation profile. The GUI 410 can allow a user to select all of the actuator(s), individual actuator(s), a plurality of actuators, one or more rows of actuators, one or more columns of actuators, one or more regions of actuators, any other subset of the actuators, or any combination thereof. When a selection of one or more actuators is made, a user can assign one or more settings, conditions, parameters, or attributes for the selected actuators. The settings can include activation time, activation duration, activation patterns (e.g., pulses), activation strength, activation speed, activation degree, activation sequence, other activation settings, and any combination thereof. The user inputs can be saved as an actuation profile.

In some instances, the GUI 410 can present a suggested activation profile to a user. The user can try the actuation profile, decline the activation profile, or modify the actuation profile. The actuation profile can be saved to the data store(s) 220 and/or to the data store 220.

In this example, the actuators are shown in a portion of the seat corresponding to the lumbar region 113 of the seat. However, it will be appreciated that the arrangements described herein are not limited in this regard. Indeed, the GUI 410 can represent actuators in other areas of the representation of the seat, such as in other portions of the back, the headrest, seat portion, bolter(s), arm rest(s), or any other portion of the seat. The GUI 410 can allow a user to select other areas of the seat. It will be appreciated that an actuation profile can cover one or more areas of the seat. For instance, a user can create an actuation profile that includes constant activation in the lumbar region while simultaneously providing a massaging effect in other areas of the user's body.

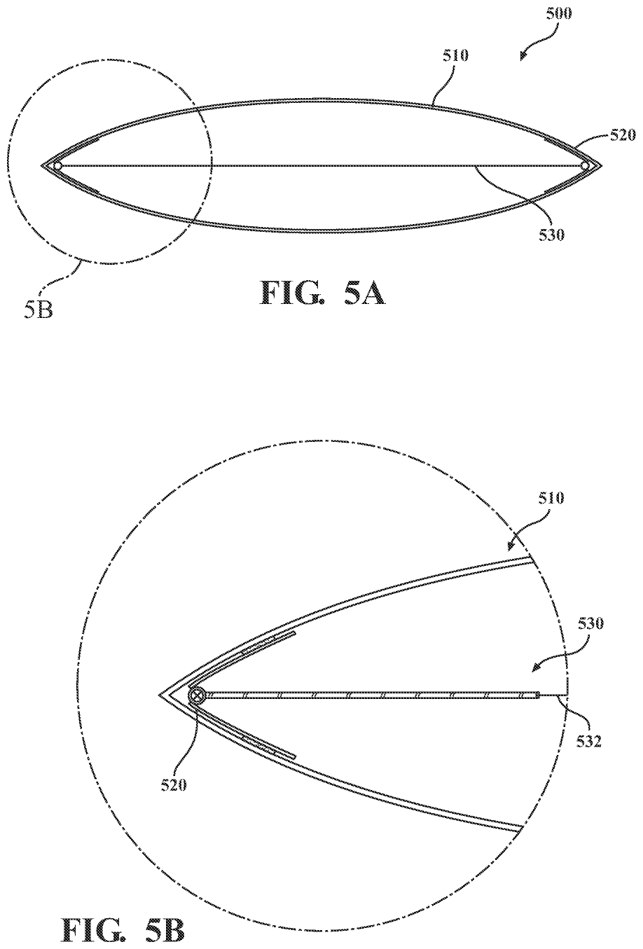

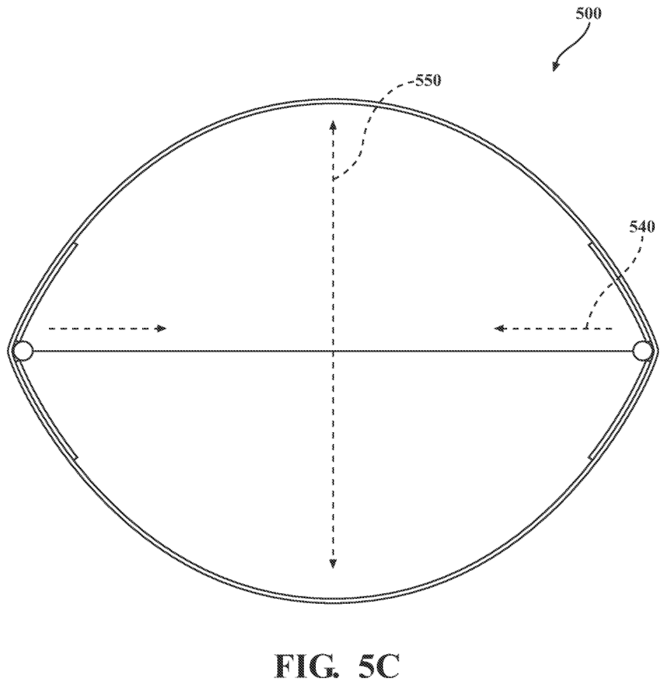

As noted above, there can be a single actuator 120 or a plurality of actuators 120. When there is a plurality of actuators, the actuators can be substantially identical to each other. Alternatively, one or more of the actuators can be different from the other actuators in one or more respects. FIGS. 5-8 show some non-limiting examples of suitable actuators.

FIGS. 5A-5C show one example of an actuator 500 suitable for use in connection with arrangements described herein. The basic details of the actuator 500 will now be described. Additional details of the actuator 500 are described in U.S. Pat. No. 10,960,793, which is incorporated herein by reference in its entirety.

The actuator 500 is depicted here with an outer skin 510, hinge assemblies 520, and an input-responsive element 30. The actuator 600 can have a first dimension 540 and a second dimension 550.

The input-responsive element 530 can include one or more elements capable of transitioning from a first configuration to a second configuration. The transition of the input-responsive element 530 from the first configuration to the second configuration displaces the hinge assemblies 520 with respect to the outer skin 510 and causes a change in confirmation of the outer skin 510. In some implementations, the input-responsive element 530 can include a SMM wire 532. The SMM wire 532 can be a shape memory alloy.

FIG. 5A shows an example of the actuator 500 in a non-activated configuration. When heated, the SMM wire 532 can contract, causing the hinge assemblies 520 to move toward one another. As a result, the actuator 500 can morph from a non-activated configuration to an activated configuration as shown in FIG. 5C. In the activated configuration, the second dimension 550 of the actuator can increase, and the first dimension 540 of the actuator 500 can decrease.

FIGS. 6A-6B show another example of an actuator 600 suitable for use in connection with arrangements described herein. The basic details of the actuator 600 will now be described. Additional details of the actuator 600 are described in U.S. patent application Ser. No. 17/729,522, which is incorporated herein by reference. FIG. 6A shows an example of the actuator 600 in a non-activated condition, and FIG. 6B shows an example of the actuator 600 in an activated condition.

The actuator 600 can include a first endcap 610 and a second endcap 620. The first endcap 610 and the second endcap 620 can be spaced apart. The actuator 600 can include a first outer member 640 and a second outer member 650. The first outer member 640 and the second outer member 650 can have a bowed shape.

The actuator 600 can include one or more shape memory material members 680. The shape memory material members 680 can be operatively connected to the first endcap 610 and the second endcap 620. The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members 680 can be shape memory material wires. As an example, the shape memory material members 680 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

As noted above, FIG. 6B is an example of the actuator 600 in an activated condition. When an activation input (e.g., electrical energy) is provided to the shape memory material member(s) 680, the shape memory material member(s) 680 can contract. This contraction causes the shape memory material member(s) 680 to pull the first endcap 610 and the second endcap 620 toward each other in a direction that corresponds to the first dimension 690.

Consequently, the ends of the first outer member 640 can be drawn toward each other in a direction that corresponds to the first dimension 690, and the ends of the second outer member 650 can be drawn toward each other in a direction that corresponds to the first dimension 690. As a result, the first outer member 640 and the second outer member 650 can bow outward and away from each other in a direction that corresponds to the second dimension 695. It will be appreciated that the first dimension 690 (i.e., the width) of the actuator 600 can decrease, and the second dimension 695 (i.e., the height) of the actuator 600 can increase.

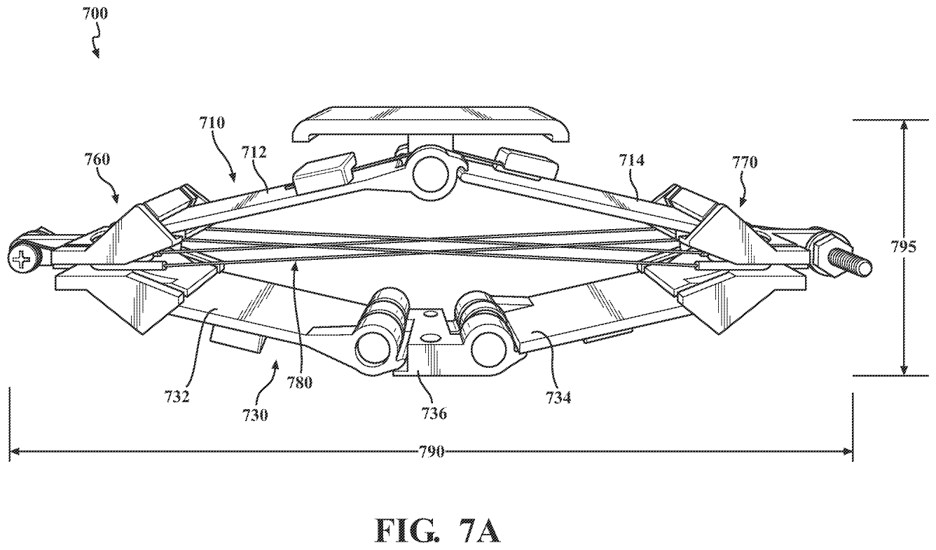

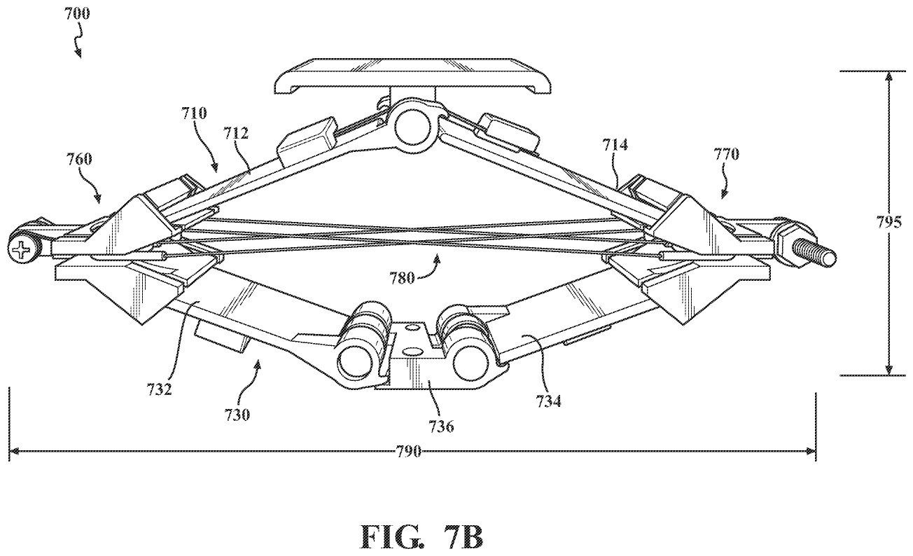

FIGS. 7A-7B show one example of an actuator 700 suitable for use according to arrangements herein. The basic details of the actuator 700 will now be described. Additional details of the actuator 700 are described in U.S. patent application Ser. No. 18/329,217, which is incorporated herein by reference.

The actuator 700 can include a first outer body member 710, a second outer body member 730, a first endcap 760, a second endcap 770, and a shape memory material member 780. The first outer body member 710 can include a first portion 712 and a second portion 714. The first portion 712 and the second portion 714 can be operatively connected to each other such that the first portion 712 and the second portion 714 can move relative to each other. In one or more arrangements, the first portion 712 and the second portion 714 can be pivotably connected to each other. For example, the first portion 712 and the second portion 714 can be pivotably connected to each other by one or more hinges. The first portion 712 and the second portion 714 can be angled relative to each other. As a result, the first outer body member 710 can have a generally V-shape.

The second outer body member 730 can include a first portion 732, a second portion 734, and a base 736. In one or more arrangements, each of the first portion 732 and the second portion 734 can be pivotably connected to the base 736. For example, the first portion 732 can be pivotably connected to the base 736 by one or more hinges, and the second portion 734 can be pivotably connected to the base 736 by one or more hinges. The first portion 732 and the second portion 734 can be located on opposite sides of the base 736.

The actuator 700 can include a first endcap 760 and a second endcap 770. The first endcap 760 and the second endcap 770 can be spaced apart. The actuator 700 can include one or more shape memory material members 780. The shape memory material member(s) 780 can extend between the first endcap 760 and the second endcap 770 in any suitable manner. The shape memory material member(s) 780 can be operatively connected to the first endcap 760 and the second endcap 770.

FIG. 7A shows an example of the actuator 700 in a non-activated configuration. Here, the shape memory material member(s) 780 are not activated. FIG. 7B shows an example of the actuator 700 in an activated configuration. When an activation input (e.g., electrical energy) is provided to the shape memory material member(s) 780, the shape memory material member(s) 780 can contract. This contraction causes the shape memory material member(s) 780 to pull the first endcap 760 and the second endcap 770 toward each other in a direction that corresponds to a first dimension 790. As a result, the first outer body member 710 and the second outer body member 730 can extend outward and away from each other in a direction that corresponds to a second dimension 795. It will be appreciated that, in going from the non-activated condition to the activated condition, the first dimension 790 (i.e., the width) of the actuator 700 can decrease and/or the second dimension 795 (i.e., the height) of the actuator 700 can increase. Further, it will be appreciated that the actuator 700 can deliver a force in a direction that is out of plane or otherwise different from the direction of contraction of the shape memory material member(s) 780.

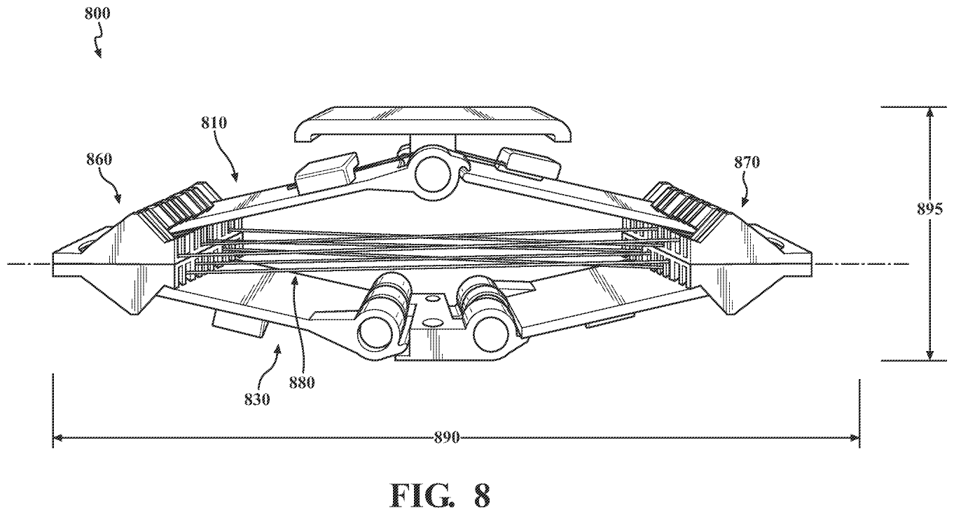

FIG. 8 shows one example of an actuator 800 suitable for use according to arrangements herein. The basic details of the actuator 800 will now be described. Additional details of the actuator 800 are described in U.S. patent application Ser. No. 18/329,217, which is incorporated herein by reference.

The actuator 800 can include a first outer body member 810, a second outer body member 830, and one or more shape memory material members 880. The actuator 800 includes a first endcap 860 and a second endcap 870. The first endcap 860 and the second endcap 870 shown in FIG. 8 are different than the first endcap 760 and the second endcap 770 shown in FIGS. 7A-7B.

FIG. 8 shows an example of the actuator 800 in a non-activated configuration. Here, the shape memory material member(s) 880 are not activated. When an activation input (e.g., electrical energy) is provided to the shape memory material member(s) 880, the shape memory material member(s) 880 can contract. This contraction causes the shape memory material member(s) 880 to pull the first endcap 860 and the second endcap 870 toward each other in a direction that corresponds to the first dimension 890. As a result, the first outer body member 810 and the second outer body member 830 can extend outward and away from each other in a direction that corresponds to the second dimension 895. It will be appreciated that, in going from the non-activated condition to the activated condition, the first dimension 890 (i.e., the width) of the actuator 800 can decrease and/or the second dimension 895 (i.e., the height) of the actuator 800 can increase.

The various examples of actuators shown in FIGS. 5-8 are merely examples and are not intended to be limiting. Other actuators are described in U.S. Patent Publication Nos. 2023/0191953 and 2023/0136197 as well as U.S. Pat. Nos. 11,370,330; 11,285,844; and 11,091,060, which are incorporated herein by reference in their entireties.

It will be appreciated that arrangements described herein can provide numerous benefits, including one or more of the benefits mentioned herein. For example, arrangements described herein can provide support to the lumbar region of a seat occupant's back. Arrangements described here can provide a different actuation effect (e.g., massaging) to other areas of a seat occupant's body simultaneously with providing lumbar support. Arrangements described herein can provide an enhanced haptic effect. Arrangements described here can provide sensor feedback loops to monitor the performance of the actuators and the seat. Arrangements described herein can enable a high degree of customization and/or programmability to a user.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . .” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A system for seat actuation comprising:
a seat;
an actuator operatively positioned relative to a lumbar region of the seat; and
one or more processors operatively connected to the actuator, the one or more processors being configured to:
cause the actuator to morph into an activated configuration to support a lumbar region of a seat occupant; and
maintain the activated configuration of the actuator, whereby a substantially continuous level of lumbar support is provided to the seat occupant.

2. The system of claim 1, wherein the actuator is located within the seat.

3. The system of claim 1, wherein causing the actuator to morph into an activated configuration to apply a force to a lumbar region of a seat occupant is performed responsive to a user input.

4. The system of claim 1 wherein, when morphing into the activated configuration, a height of each of the actuator increases.

5. The system of claim 1, wherein causing the actuator to morph into an activated configuration to apply a force to a lumbar region of a seat occupant is performed automatically by the one or more processors.

6. The system of claim 1, wherein the seat is located onboard a vehicle.

7. The system of claim 1, further including a second actuator, wherein the second actuator is operatively positioned with respect to one or more non-lumbar regions of the seat, and wherein the one or more processors are further configured to activate the second actuator to provide a massaging effect to the seat occupant, whereby the massaging effect and the lumbar support are provided simultaneously.

8. The system of claim 1, wherein each of the actuator includes a contracting member, wherein, when an activation input is provided to the contracting member, the contracting member contracts, thereby causing the actuator to morph into an activated configuration.

9. The system of claim 8, wherein the contracting member is a shape memory material member.

10. The system of claim 9, wherein the shape memory material member is a shape memory alloy wire.

11. The system of claim 1, further including a sensor operatively connected to the one or more processors, wherein the sensor is operatively positioned to acquire sensor data about the actuator, and wherein the one or more processors are configured to adjust the activated configuration of the actuator based on the sensor data.

12. The system of claim 11, wherein the sensor is a flexing sensor or rotational position sensor.

13. The system of claim 11, wherein the one or more processors are configured to adjust the activated configuration of the actuator so that maintain the substantially continuous level of lumbar support.

14. The system of claim 1, wherein the actuator is a plurality of actuators.

15. A method of seat actuation for lumbar support, an actuator being operatively positioned relative to a lumbar region of a seat, one or more processors being operatively connected to the actuator, the method comprising:
causing the actuator to morph into an activated configuration to support a lumbar region of a seat occupant; and
maintaining the activated configuration of the actuator, whereby a substantially continuous level of lumbar support is provided to the seat occupant.

16. The method of claim 15, wherein maintaining the activated configuration of the actuator includes:
acquiring sensor data about the actuator; and
adjusting the activated configuration of the actuator based on the sensor data.

17. The method of claim 15, wherein the actuator is a first actuator, and further including a second actuator operatively positioned relative to a non-lumbar region of the seat, the method further including:
causing the second actuator to be activated, the second actuator providing a different sensation to the seat occupant than the first actuator.

18. The method of claim 17, wherein the different sensation is a massaging effect.

19. The method of claim 15, wherein causing the actuator to morph into an activated configuration to support a lumbar region of a seat occupant is performed responsive to a user input.

20. The method of claim 15, wherein actuator includes a contracting member, and wherein causing the actuator to morph into an activated configuration to support a lumbar region of a seat occupant includes providing an activation input to the contracting member of the actuator.
